(19) United States
(12) Patent Application Publication
(10) Pub. No.: US 2008/0111333 A1
(43) Pub. Date: May 15, 2008

(54) Gravity propelled low profile seat-carrying vehicles supported by surface-engaging wheels and related methods

(76) Inventors: Merrill Oveson, Orem, UT (US); Richard M. Oveson, Provo, UT (US)

Correspondence Address: Lynn G. Foster, Suite C3, 65 N Street, Salt Lake City, UT, 84103, US

(21) Appl. No.: 11/999,557

(22) Filed: Dec. 5, 2007

Related U.S. Application Data
(63) Continuation-in-part of application No. 29/264,884, filed on Aug. 21, 2006, now Pat. No. D562914.

(51) Int. Cl. B62M 1/00

(52) U.S. Cl. 280/87.021

(57) ABSTRACT

Low profile motorless vehicles and related methods are disclosed, the vehicles being without a propulsion mechanism, without a steering mechanism other than by shifting body weight and without a braking mechanism and are easy to learn to use and to use, safer to operate and appealing to the full range of humanity including very young children, youth, teenagers, young adults and older adults.

This application is a continuation-in-part of co-pending U.S. patent application Ser. No. 29/264,884, filed Aug. 21, 2006.

### FIELD OF THE INVENTION

The present invention relates generally to motorless gravity propelled vehicles and, more particularly to low profile seat carrying gravity propelled vehicles and related methods, the vehicles having a base upon which the seat is superimposed with surface-engaging wheels secured below the base.

### BACKGROUND

Motorless vehicles comprising ground/surface engaging rotationally aligned wheels, without a steering mechanism, other than by shifting the body weight and without a propulsion mechanism other than by pushing using some part of the body (i.e. skateboards) have been popular since the early 1970s. These vehicles necessitate a learning phase, during which injuries are not uncommon. In fact, even experienced riders of such vehicles often experience injuries both insignificant and severe.

The reason for these injuries is three fold: a) such vehicles, as are generally available in today's market, have no mechanism for braking, nor do they possess any other reasonable means of allowing the rider to brake (i.e. in the event that a rider of such a vehicle needs to slow down or stop he/she is forced to either exit the vehicle altogether often resulting in the rider being forced to run faster than he/she is able which consequently causes him/her to fall violently or attempt to drag a body part such as a foot which results in the rider having to put the majority of his/her weight on only one foot which causes the rider to lose his/her balance and fall); and b) such vehicles, by the fact such vehicles were designed to be ridden while standing, are inherently unstable. Often riders of such vehicles experience “speed wobble” which results when the vehicle begins to wobble beyond the control of the rider. “Speed wobble” often causes the rider to be violently thrown from the vehicle. The fact that the rider is usually standing, as per accepted standard riding stance, presents all riders with the potential of a fall where body parts are at great risk, i.e. legs, arms, hands, internal organs and most importantly face, neck and head.

### BRIEF SUMMARY AND OBJECT OF THE INVENTION

In a brief summary, the present invention overcomes or substantially alleviates the above stated problems. Novel low profile motorless vehicles, and related methods, comprise this invention, i.e. motorless vehicles which lack a propulsion mechanism, lack a steering mechanism, other than by the shifting of body weight, and lack of a mechanical braking system, yet allow the rider to easily brake using his/her feet, are inherently stable and are easy to learn and use. This invention is safe to operate and appeals to the full range of humanity including very young children, youth, teenagers, young adults, the middle aged and the elderly.

Such an invention addresses the problems of instability and braking by providing a seat attached to a solid surface which surface has ground engaging wheels—which wheels allow steering by the shifting of body weight.

Instability is overcome simply by the fact that the rider is sitting. Sitting accomplishes two things: a) the vehicle along with rider has an intrinsically low center of gravity—much lower than skateboards (this prevents “speed wobble”); and b) the rider, in the event of a mishap, has a much shorter distance to the ground. The lack of reasonable braking is overcome because the rider no longer relies on his/her feet to remain on the vehicle since the rider is sitting on the vehicle, leaving the feet to free to brake by simply by placing the feet on the ground. The method of braking also helps alleviate “speed wobble” as riders can simply use their feet to slow down and thus regain control of the vehicle. Sturdy closed toe rubber soled shoes are, of course, recommended.

With the foregoing in mind, it is a primary object of this invention to overcome or substantially alleviate problems of the past concerning motorless vehicles of the type mentioned above.

It is a further paramount objective to provide low profile motorless vehicles, and related methods, the vehicles being without a propulsion mechanism, without a steering system, other than by shifting of body weight, and without a braking mechanism and are easy to learn to use and easy to use, safe to operate and appealing to the full range of humanity including very young children, youth, teenagers, young adults and older adults.

Further objects of the invention will become evident in the description below.

### BRIEF DESCRIPTION OF THE DRAWINGS

FIG. 1 is a top perspective of one embodiment in accordance with the principles of the present invention;

FIG. 2 is a side elevational view of the embodiment of FIG. 1;

FIG. 3 is a bottom plan view of the embodiment of FIG. 1;

FIG. 4 is a side elevational view of a second embodiment implementing the principles of the present invention, wherein the base and the chair frame are formed as one piece;

FIG. 5 is a top elevational view of the embodiment of FIG. 4;

FIG. 6 is a front elevational view of the embodiment of FIG. 4; and

FIG. 7 is a bottom elevational view of the embodiment of FIG. 4;

FIG. 8 is a top perspective of a third embodiment of the present invention wherein the base and the chair are force-fit together.

FIG. 9 is a bottom perspective of the embodiment of FIG. 8;

FIG. 10 is a side elevation of the embodiment of FIG. 8;

FIG. 11 is a side elevation of the embodiment of FIG. 8;

FIG. 12 is an enlarged fragmentary cross section taken along lines 12-12 of FIG. 8.

### DETAILED DESCRIPTION OF THE ILLUSTRATED EMBODIMENTS

The present invention is directed to low-profile motorless vehicles and related methods, the vehicles being without a propulsion mechanism, without a steering mechanism, other than by shifting body weight, and without a braking mechanism, the vehicles being easy to learn to use and easy to use, safe to operate, and appealing to the full-range of humanity, including very young children, youth, teenagers, young adults and older adults.

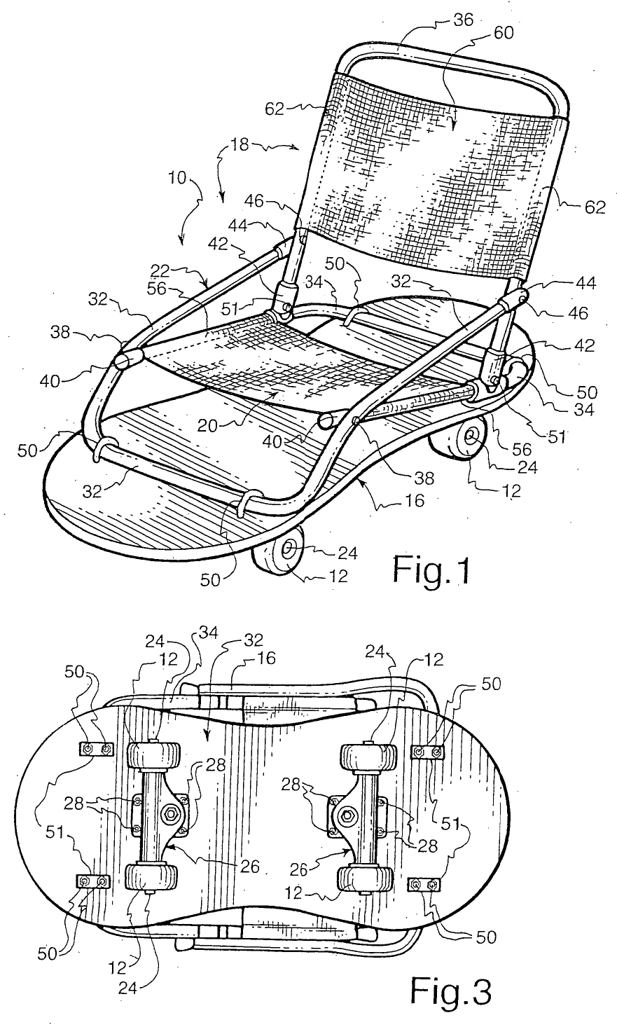

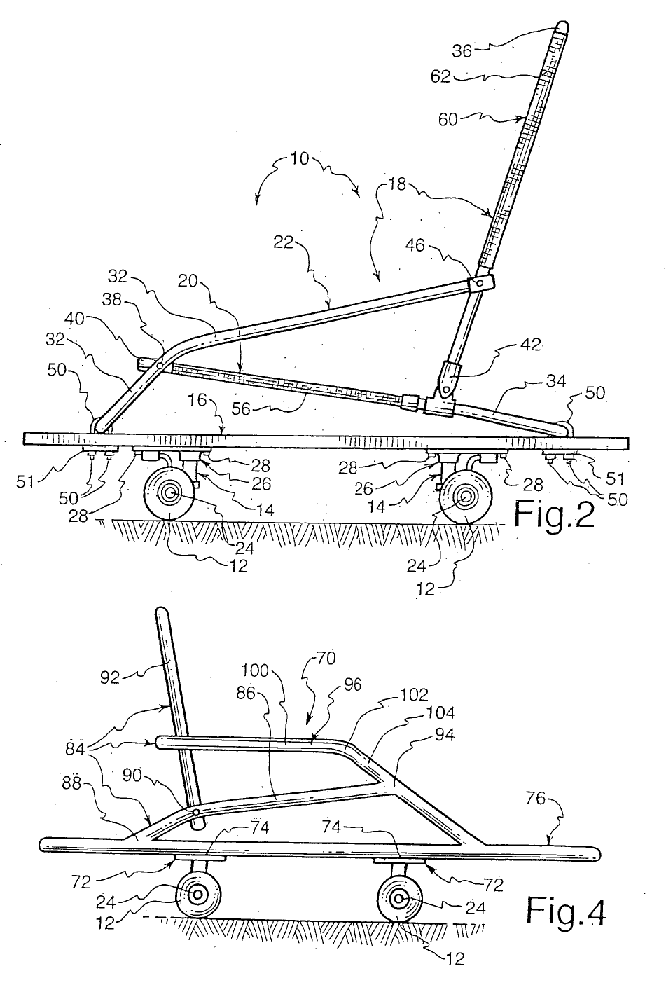

One embodiment in accordance with the present invention is illustrated in FIGS. 1-3, to which reference is now made, it being understood that like numerals are used throughout this detailed description to designate like parts. FIG. 1 illustrates a motorless vehicle, generally designated 10, which is without a propulsion mechanism, without a steering mechanism, other than by shifting body weight, and without a braking mechanism. Vehicle 10 comprises surface-engaging wheels 12, forming a part of two wheel mechanisms, generally designated 14 (FIG. 2), and a base or platform, generally designated 16. The wheel mechanisms 14 are anchored in fixed relationship to the base or platform 16 so as to create a low-profile sub-assembly, i.e. having only a very short vertical dimension.

Motorless vehicle 10 further comprises a chair, generally designated 18, which comprises a seat, generally designated 20, and a chair frame, generally designated 22. The wheel assemblies 14, the base or platform 16 and the seat 20 together comprise a low-profile assembly so that the user's center of gravity is very low to the ground, producing exceptional stability when the motorless vehicle 10 is utilized.

As can be seen from FIG. 3, the four wheels 12 are idler wheels which freely rotate in aligned relation on their respective axles 24. As can be seen from FIG. 3, the wheels are aligned in two spaced parallel planes so as to typically accommodate generally linearly displacement of the motorless vehicle 10. The axles of the rear two wheels 12 are non-rotatably carried by an associated axle housing 26, which is commercially available. The two front and the two rear wheels 12, are rotatably mounted on their associated axles 24. Each axle 24 is carried non-rotatably by the associated axle housing 26. The orientation of front axle housing 26 is opposite to that of the rear axle housing 26, but otherwise identical. Fasteners 28 secure the two axle housings 26 to the underside of the platform or base 16.

The base may be formed of any suitable material, such as metal, wood, a composite, graphite and synthetic resinous material. It is important that platform 16 be durable to accommodate multiple uses of the motorless vehicle 10. The length of the base or platform 16 may be of any suitable length, adequate to accommodate and accomplish the purposes of the present invention. The width of the base or platform 16 should be sufficient to accommodate receipt of the chair 18 and placement of the feet of the user comfortably on the base or platform 16, when the motorless vehicle 10 is being propelled by gravity and/or the use of the feet of the human occupant. The feet may be selectively placed upon the wheel-engaging surface, such as a paved street, to control speed and to stop the vehicle 10. The feet may also be used to manually propel the vehicle 10. Steering is accomplished by shifting of body weight.

The chair frame 22 comprises essentially three interconnected U-shaped frame members 32, 34 and 36. U-shaped frame member 32 is pin-connected at both sites 38 to the forwardly directed ends 40 of U-shaped frame member 34. Upwardly directed chair frame member 36 is connected to frame member 34 utilizing T-connectors 42 and pins 51, while the rearwardly directed ends 44 are pin-connected at 46 to frame member 36, all as best shown in FIG. 1.

The chair 18 is held in a fixed position by its connection to the base or platform 16 utilizing four spaced U-bolts 50, which pass through the base or platform 16 through apertures and are secured by nuts against the exposed surface of an associated plate 51.

The seat 20 spans between the two arms of the frame member 34. While other materials could be utilized, rigid or flexible, the seat 20 illustrated in FIGS. 1-3 comprises a strong fabric, such as canvas, having an eyelet 56 stitched in each end through which the two forwardly extending arms of the frame member 34 loosely extend. Thus, the human user of the vehicle 10 may comfortably sit upon, place his or her weight on the seat 20 in a low center of gravity position and safely use the vehicle 10 in stable relation.

A chair back 60 spans between the two spaced downwardly directed arms of frame member 36. While other materials could be utilized, rigid or flexible, the chair back 60 illustrated in FIGS. 1-3 comprises a strong fabric, such as canvas, having an eyelet 62 stitched in each end through which the two downwardly extending arms of the frame member 36 loosely extend. During use, the human user may rest his or her back against the chair back 60, for both comfort and stability.

As is readily apparent from observation of FIGS. 1-3, motorless vehicle 10 is low profile, and highly stable. One may readily learn to use and safely use the motorless vehicle 10 while resting on seat 20. There is little risk that the base or platform 16 will tip over. Excessive speeds are prevented by the user placing his or her shoes on the surface engaged by wheels 12 and yet the user may shift his or her body to alter the direction of travel of the motorless vehicle 10 as desired when being used. There is little risk that the vehicle 10 will strike a non-rider while being used, because control by the user is substantial. The full range of humans, from young to old, can readily learn and thereafter conveniently use the motorless vehicle 10, which is propelled by placing the feet on the surface engaged by the wheels 12 and pushing or by the force of gravity or both.

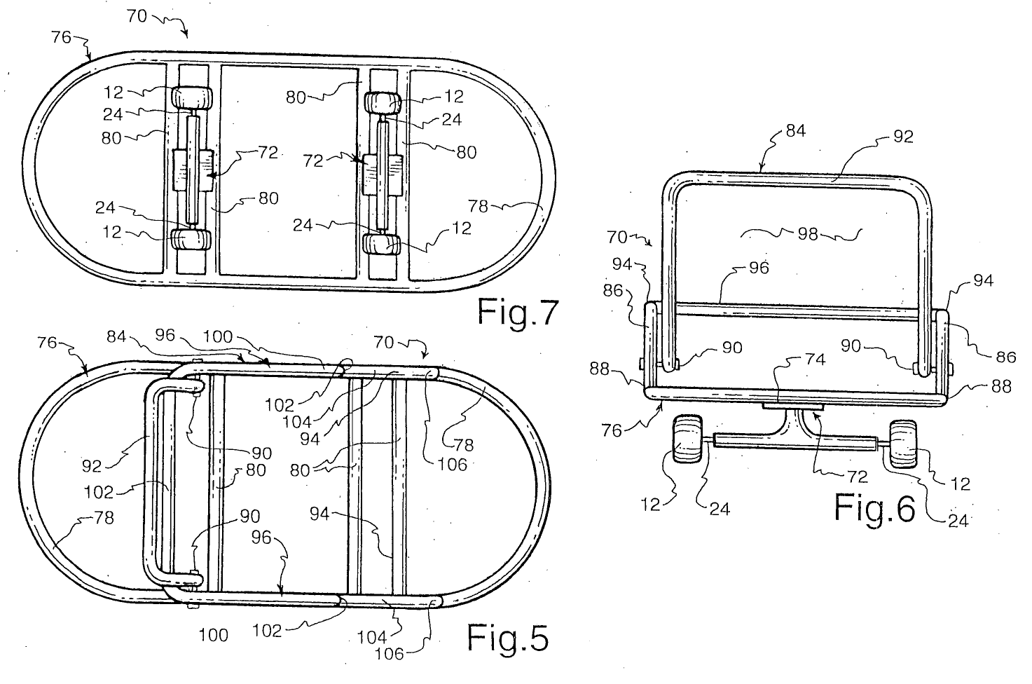

Reference is now made to FIGS. 4-7, which illustrate a second embodiment of the present invention, i.e. motorless vehicle 70. Motorless vehicle 70 comprises four idler wheels 12 mounted upon non-rotatable axles 24, both of which are described above. Each axle 24 is non-rotatably mounted in a commercially available axle housing 72. Each of the two axle housings 72 are connected at sites 74 to a base 76 so that the wheels 12 are aligned in two spaced parallel planes for smooth rotation.

The base 76 is illustrated as comprising a peripheral member 78, which is somewhat oval in its configuration and two closely spaced pairs of cross members 80. The connection 74 is between each axle housing 72 and an associated pair of cross members 80, as best shown in FIG. 7. The base may be formed of any suitable material, configurated in any suitable way. If desired, the base 76 may be formed of metal or synthetic resinous tubing. The base may be formed of synthetic resinous material using available injection molding techniques. In the Figures, which are exemplarily and not limiting, the cross members 80 are shown as being formed as one piece with the perimeter member 78. The base 76 is illustrated as being disposed in a horizontal plane when the wheels 12 engage a horizontal surface.

Motorless vehicle 70 also comprises a chair frame formed as one piece with the base 76, the chair frame being generally designated 84. The chair frame 84 comprises a seat frame member 86 between which a seat (of the type described above but not shown) will extend. The seat may be of rigid or flexible material, as determined by those skilled in the art. The chair frame 84 may be of injection mold synthetic resinous material formed as one piece with the base or if desired, formed separately and connected thereto, as by plastic welding or in some other suitable way. FIG. 4 shows the base formed as one piece with the chair frame. The spaced seat frame members 86 integrally connect at sites 88 to the base peripheral member 78, at pin 90 to a back frame member 92 and at sites 94 to an arm rest member 96. The back frame member 92 is generally U-shaped defining an open area 98 across which a backing member (of the type described above but not shown) will extend, which may be either rigid or flexible as determined by those skilled in the art.

Arm rest member 96 is generally U-shaped with two side members 100 vertically above peripheral base member 78 and connected by a cross piece 102, which provides contiguous support for the back frame member 92. Each arm rest member 100 comprises an outside corner 102 and a downwardly diagonal extension 104 which comprises site 94 and merges integrally and as one piece at site 106 with base perimeter member 78.

The advantages and benefits of the motorless vehicle 70 embrace those described above in conjunction with motorless vehicle 10. The user may place his or her upon the perimeter base member 78 when the vehicle 70 is propelled by gravity and may remove the feet and place them on the surface engaged by wheels 12 to push the vehicle or to brake the vehicle when and as desired.

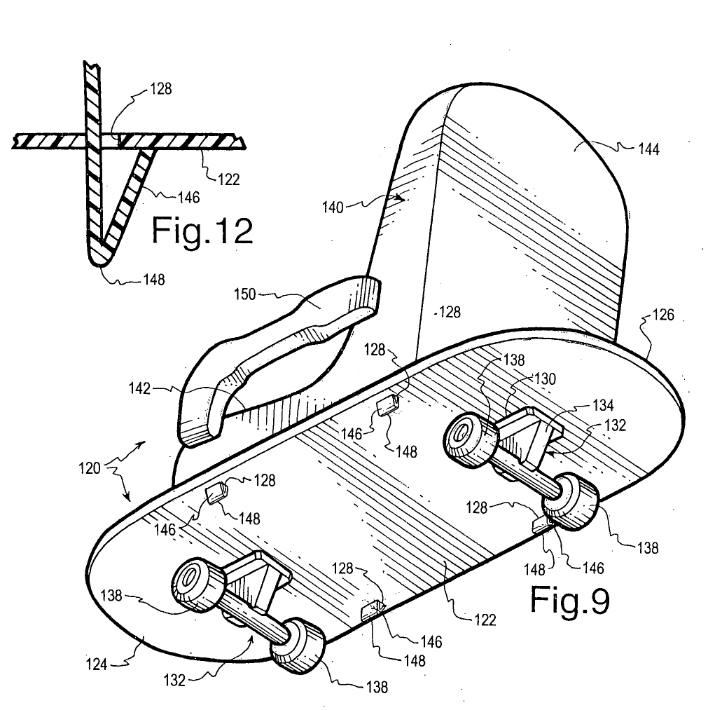

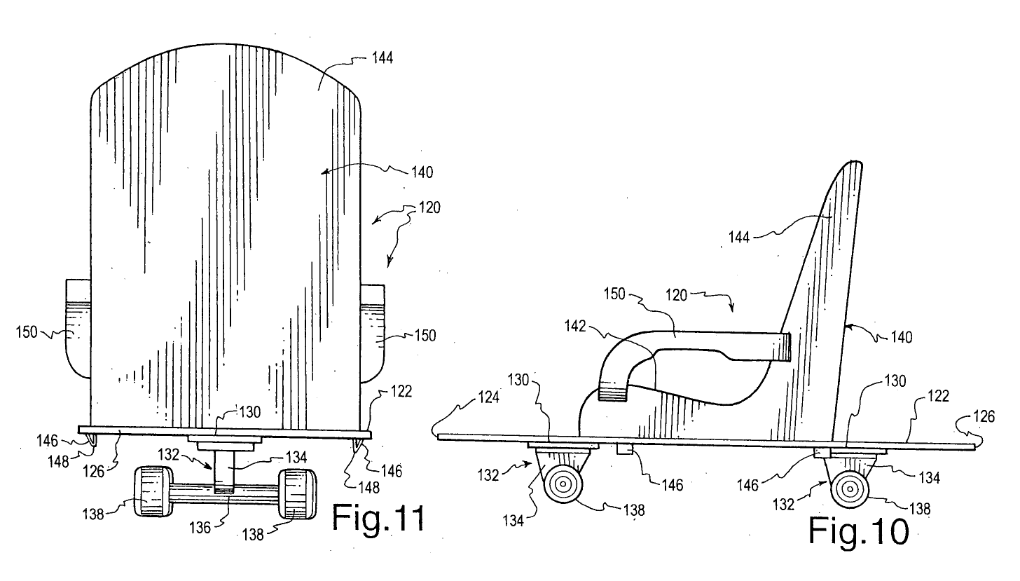

Reference is now made to the embodiment of FIGS. 9-12, which depicts an additional version of the present invention, generally designated 120. The vehicle 120 comprises a planar base 122 having a uniform width and rounded front and rear edges 124 and 126. The flat base 122 may be formed of any suitable material including metal, composite and synthetic resinous material. The base is comprises of four vertical slots or apertures 128 for purposes yet to be explained.

Two wheel assemblies 132, front and back are secured to the base 122 at sites 130, in any suitable way, such as by use of fasteners and/or a bonding agent. The wheel assemblies, 132 each comprise a mounting support 134, an axle 136 and a pair of rotatable wheels 138 at each end of each axle. The wheel assemblies 132 are conventional and commercially available.

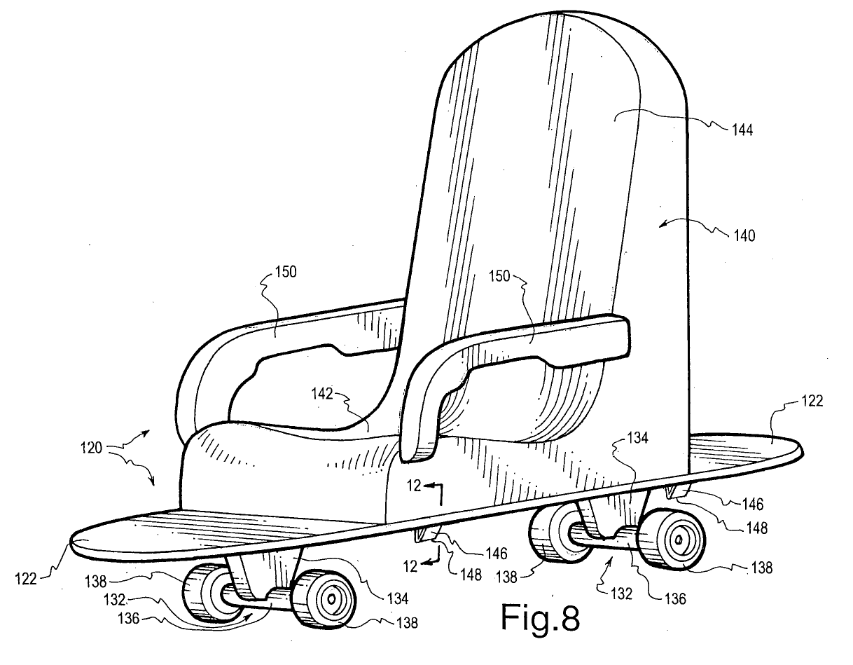

An injection molded chair 140 comprising a seat 142 and a backrest 144 is superimposed upon the top surface of the base 122 and secured in that position by four deflectable barbs 146 (FIG. 12). Each barb 146 is force fit, through the associated one of the apertures 128. More specifically, the barbs 146 are somewhat flexible and collapsed when pushed pointed end 148 first through the associated aperture 128 until the barb 146 clears the aperture 128 at which time the barb expands, due to the memory of the material comprising the barb, into the position of FIG. 12, thereby causing the chair to be held in a fixed position contiguously upon the base 122, as best illustrated in FIG. 8.

The chair is illustrated as comprising arm rests 150, but these are not essential. The arm rests 150 may be secured in any suitable way to the chair 140. Plastic welding, fasteners, bonding agent and/or the like may be used to appropriately secure the arm rests 150 in position. It is to be appreciated that the chair 140 is illustrative. The chair may have any desired configuration and could be formed of materials other than injection molded plastic, as best determined by those skilled in the art.

The advantages, features and mode of operation of the vehicle 120 are essentially the same as those described above in conjunction with the other embodiments.

While this invention has been described with reference to certain specific embodiments and examples, it will be recognized by those skilled in the art that many variations are possible without departing from the scope and spirit of the invention, and that the invention, as described and claimed, is intended to cover all changes and modifications of the invention which do not depart from the spirit of the invention.

What is claimed is:

1. A low profile motorless vehicle propelled by gravity supplemented as desired by manual force comprising:
at least four spaced surface-engaging rotatable wheels;
a rigid base superimposed over the wheels, the wheels being rotatably connected to the base for rotation;
a low profile seat immediately above the base for supporting a human user seated thereon, the seat being integrally connected to the base in a superimposed relation accommodating steering while seated by shifting the body of the user and braking by forcible placement of the feet on the surface while seated.

2. A vehicle according to claim 1 wherein the base comprises a platform.

3. A vehicle according to claim 1 wherein the seat comprises an elevated frame securely mounted to the base in fixed though disassembleable relation.

4. A vehicle according to claim 1 wherein the seat comprises a bottom portion for receiving and supporting a human in a seated position with the feet selectively placeable on the base and on the surface for braking purposes.

5. A vehicle according to claim 4 wherein the seat comprises a back portion above the bottom portion against which the human may lean.

6. A vehicle according to claim 1 wherein the base comprises a frame upon which the seat is mounted.

7. A vehicle according to claim 1 wherein the base and seat are formed as one piece.

8. A vehicle according to claim 1 wherein the base and seat are integrated by male and female force-fit connections.

9. A method of making low profile motorless vehicles propelled by gravity supplemented as desired by manual force comprising the acts of:
providing at least four spaced surface-engaging rotatable wheels;
providing a rigid base;
superimposed rigid base over the position retaining the wheels and rotatably connecting the wheels to the base for aligned rotation;
superimposing a low profile seat immediately above the base and integrally connecting the seat to the base for supporting a human user to the base in a superimposed relation accommodating steering by shifting body weight without a steering mechanism and braking without a braking system by forcible placement of the feet on the surface.
